(19) United States
(12) Patent Application Publication
(10) Pub. No.: US 2024/0221410 A1
(43) Pub. Date: Jul. 4, 2024

(54) PICTURE PROCESSING METHOD, APPARATUS, ELECTRONIC DEVICE, AND STORAGE MEDIUM

(71) Applicant: SAMSUNG ELECTRONICS CO., LTD., Suwon-si (KR)

(72) Inventors: Yiwen YANG, Guangzhou (CN); Jianxing Liang, Guangzhou (CN); Jie Zhang, Guangzhou (CN); Cheng Chen, Guangzhou (CN); Meng Wang, Guangzhou (CN); Yingjie Liang, Guangzhou (CN); Wangqi Li, Guangzhou (CN)

(73) Assignee: SAMSUNG ELECTRONICS CO., LTD., Suwon-si (KR)

(21) Appl. No.: 18/540,457

(22) Filed: Dec. 14, 2023

(30) Foreign Application Priority Data
Jan. 4, 2023 (CN) 202310008704.2

(51) Int. Cl. G06V 30/24; G06V 30/14; G06V 30/148; G06V 30/19; G06V 30/30

(52) U.S. Cl. CPC G06V 30/24; G06V 30/1444; G06V 30/15; G06V 30/191; G06V 30/30

(57) ABSTRACT

A picture processing method performed by an electronic device, includes: acquiring a target picture; performing region type detection and character recognition on the target picture by combining a target type detection technology and an optical character recognition technology, determining a target region to be occluded from the target picture based on a result of the region type detection and a result of the character recognition, and occluding the target region in the target picture.

### CROSS-REFERENCE TO RELATED APPLICATION

This application claims priority to Chinese Patent Application No. 202310008704.2, filed on Jan. 4, 2023, in the National Intellectual Property Administration of P.R. China, the disclosure of which is incorporated by reference herein its entirety.

### BACKGROUND

### 1. Field

The disclosure relates to a computer technology field and, specifically, to a picture processing method, an apparatus, an electronic device, and a storage medium.

### 2. Description of Related Art

With the development of technologies, an electronic device (or a terminal) has more and more functions. A user can use the electronic device to share various types of content, such as a picture, a video, a file, a recording, and so on. When sharing content with others, the content may involve the user's privacy information that the user may not want to share. Therefore, it is necessary to occlude or redact a part of the shared content that involves the user's privacy information to ensure the user's privacy security.

In related art technologies, when identifying privacy information of content to be shared, some privacy information may be incorrectly identified or missed to identify. For example, when the content to be shared contains multiple lines of information, some cross-line privacy information cannot be accurately identified, and thus, the accuracy of privacy information identification is poor.

### SUMMARY

Provided are a picture processing method, an apparatus (or a picture processing apparatus), an electronic device, and a storage medium.

According to an aspect of the disclosure, a picture processing method performed by an electronic device includes obtaining a target picture. The picture processing method further includes performing region type detection and character recognition on the target picture by combining a target type detection technology and an optical character recognition technology. The picture processing method further includes determining a target region to be occluded from the target picture based on a result of the region type detection and a result of the character recognition. The picture processing method further includes occluding the target region in the target picture.

According to an aspect of the disclosure, an electronic device includes at least one processor, and a memory storing instructions. The at least one processor is configured to execute the instructions to obtain a target picture. The at least one processor is further configured to perform region type detection and character recognition on the target picture by combining a target type detection technology and an optical character recognition technology. The at least one processor is further configured to determine a target region to be occluded from the target picture based on a result of the region type detection and a result of the character recognition. The at least one processor is further configured to occlude the target region in the target picture.

According to an aspect of the disclosure, a computer readable storage medium stores instructions which are executed by a processor of an electronic device to perform a picture processing method including obtaining a target picture. The picture processing method further includes performing region type detection and character recognition on the target picture by combining a target type detection technology and an optical character recognition technology. The picture processing method further includes determining a target region to be occluded from the target picture based on a result of the region type detection and a result of the character recognition. The picture processing further includes occluding the target region in the target picture.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a flowchart showing a picture processing method according to an embodiment of the disclosure;

FIG. 2 is a schematic diagram showing a result of region type detection according to an embodiment of the disclosure;

FIG. 3 is a schematic diagram showing an overall design of an NLP module according to an embodiment of the disclosure;

FIG. 4 is a schematic diagram showing a processing flow of an NLP module according to an embodiment of the disclosure;

FIG. 5 is a schematic diagram of splitting, truncating and occluding a character region based on a line number corresponding to a word, an entity content region and a non-entity content region according to an embodiment of the disclosure;

FIG. 6 is a schematic diagram showing an effect of displaying a target picture before and after a target region is occluded through an animation mode according to an embodiment of the disclosure;

FIG. 7 is a schematic diagram showing an effect of displaying a target picture before and after a target region is occluded through a left and right split screen mode according to an embodiment of the disclosure;

FIG. 8 is a schematic diagram showing a user's operation on a “username” region in a split screen page according to an embodiment of the disclosure;

FIG. 9 is a schematic diagram showing an effect of displaying a target picture before and after a target region is occluded through an up and down split screen mode according to an embodiment of the disclosure;

FIG. 10 is a schematic diagram showing a user's sliding operation in a split screen page according to an embodiment of the disclosure;

FIG. 11 is a schematic diagram showing a user's operation on a non-occluded region in a split screen page according to an embodiment of the disclosure;

FIG. 12 is a schematic diagram of hovering over an “avatar” region of a picture by a user using a stylus according to an embodiment of the disclosure;

FIG. 13 is a flow chart showing privacy information identification and occlusion by using a serial mode for according to an embodiment of the disclosure;

FIG. 14 is a flow chart showing privacy information identification and occlusion by using a parallel mode according to an embodiment of the disclosure;

FIG. 15 is a block diagram showing a picture processing apparatus according to an embodiment of the disclosure; and

FIG. 16 is a block diagram showing an electronic device according to an embodiment of the disclosure.

### DETAILED DESCRIPTION

In order to make those skilled in the art better understand the technical solutions of the disclosure, the technical solutions in the embodiments of the disclosure will be clearly and completely described below with reference to the accompanying drawings.

The terms “first”, “second” and the like in the description and claims as well as the above drawings of the disclosure are used to distinguish similar objects and are not necessarily used to describe a specific order or sequence. It should be understood that the data used in this way may be interchanged under appropriate circumstances, so that the embodiments of the disclosure described herein can be implemented in an order other than those illustrated or described herein. The embodiments described in the following embodiments are not representative of all embodiments consistent with the disclosure. Rather, they are only examples of devices and methods consistent with some aspects of the disclosure as detailed in the appended claims.

It should be noted here that “at least one of several items” in the disclosure means that these three parallel situations of “any one of the several items”, “any combination of the several items”, and “all of the several items” are included. For example, “including at least one of A and B” includes the following three parallel situations: (1) including A; (2) including B; (3) including A and B. Another example is “to execute at least one of Step 1 and Step 2”, which means the following three parallel situations: (1) execute Step 1; (2) execute Step 2; (3) execute Step 1 and Step 2.

With the popularity of smart terminals (or smart electronic devices), a user may use a smart terminal (or a smart electronic device) to share various files with friends, family members and colleagues, such as a picture, a video, a document, a recording, etc. When sharing a file, there is a risk that the user's personal privacy information may be disclosed. In related technologies, in order to protect the security of the user's personal privacy data, the user's privacy information that may be contained in the file to be shared may be automatically detected, and the data involving user privacy will be automatically shielded, occluded, redacted, covered or coded.

However, there may be the following problems when using the relevant technologies to identify privacy information:

(1) It is easy to miss to cover or incorrectly cover the privacy information.

(2) An entity name in a cross-line text may not be recognized and thus may not be covered.

(3) Some automatically shielded content is not what the user wants to cover. The user needs to click multiple shielded regions to view and confirm what is to be covered and what is not to be covered, which is very inconvenient.

In order to solve the above problems in the related technologies, the picture processing methods, apparatuses, electronic devices and storage media provided by the disclosure may reduce the phenomenon that privacy information is incorrectly identified or missed to be identified by performing the region type detection and the character recognition on the target picture through combining the target type detection technology and the optical character recognition technology; in addition, it may also realize the recognition of entity content in newline words, ensure that cross-line privacy information may be accurately identified, and the accuracy of privacy information identification is high.

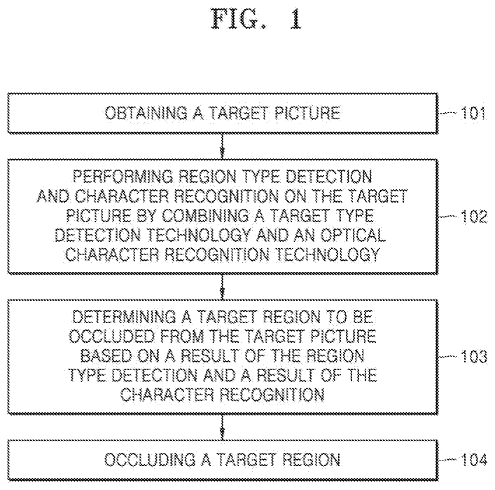

FIG. 1 is a flowchart showing a picture processing method according to an embodiment of the disclosure, which is used by an electronic device 1600 (or a terminal).

Referring to FIG. 1, in operation 101, the electronic device 1600 may obtain (or acquire) a target picture. For example, when a user performs a screenshot operation, the electronic device 1600 may determine (or identify) whether a current display interface is an instant messaging group interface, that is, whether the current display interface is a chat interface. If it is determined (or identified) that the current display interface is the chat interface, the electronic device 1600 may trigger a privacy information shield function for a chat interface screenshot obtained through the screenshot operation. For example, the electronic device 1600 may perform privacy information identification and privacy information occlusion for the chat interface screenshot.

For example, when the user opens a picture in a gallery, the electronic device 1600 may determine (or identify) whether the opened picture is a chat interface picture using a two-category artificial intelligence (AI) model. If it is determined that the picture currently opened by the user is the chat interface picture, the electronic device 1600 may trigger (or perform) the privacy information shield function for the chat interface picture.

The “privacy information”, i.e., “preset privacy type” referred to in the disclosure may include, but not limited to, the following items: a name, an avatar, an ID card number, an instant messaging group title, a phone number, a bank card account number, a license plate number, an address, an email, an express number, a flight number, a thumbnail (or an indicator or an image) representing a user or the like.

In operation 102, the electronic device 1600 may perform region type detection and character recognition on the target picture by combining a target type detection technology (Object Detection, OD) and an optical character recognition technology (Optical Character Recognition, OCR).

The privacy information identification of the target picture in the disclosure may be realized in two different ways, namely a “serial mode” and a “parallel mode”. The “serial mode” may include that an OD module and an OCR module are serial. For example, the “serial mode” is, that the OCR module performs an operation such as screenshot by category in an output result of the OD module, and then performs character recognition on an intercepted region. The OD module may perform a task of detecting the privacy information (or an object or sensitive objects) from the target picture (or an image). The OCR module may perform a task for character recognition from the target picture by applying a technology that enables an electronic conversion of printed or handwritten text into machine-readable text.

The “parallel mode” may indicate that the OD module and the OCR module are arranged in parallel. The “serial mode” is relatively simple to implement, but it depends on the accuracy of the OD module, for example, an accuracy rate of the OD module, a recall rate of the OD module, an mAP (mean Average Precision) of the OD module, and so on. The mAP of the OD module may be a metric used to evaluate the performance of object detection models. The mAP may measure how well an object detection model can detect the region types from the target picture and how accurately locations of the detected region types can be predicted.

A total of five region types may be obtained by performing the region type detection on the target picture using the OD module, including “chat content (content)”, “other content (other)”, “a chat title (title)”, “a username of an account (username)”, and “an avatar of an account (avatar)”.

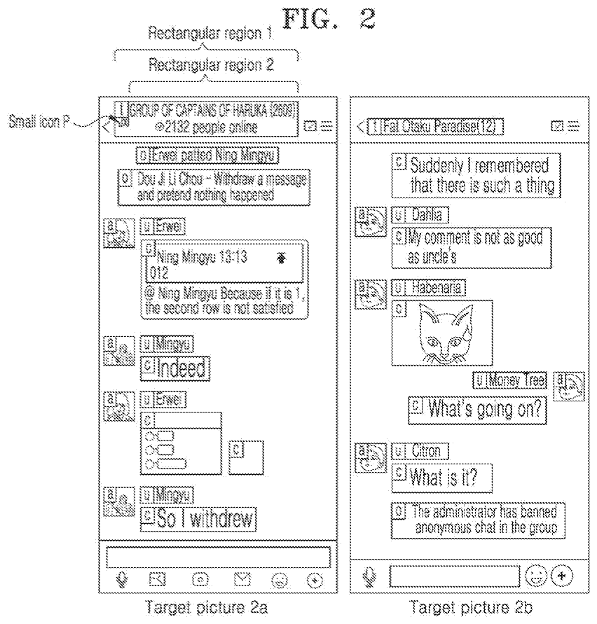

FIG. 2 is a schematic diagram showing a result of region type detection according to an embodiment of the disclosure. Referring to FIG. 2, there are two target pictures in FIG. 2, namely a target picture 2a and a target picture 2b. The OD module has detected the above five region types in both the target picture 2a and the target picture 2b, and a first type region and a second type region obtained by performing the region type detection of the target pictures by the OD module may be rectangular regions (a rectangular region 1, a rectangular region 2), where:

“Title”, abbreviated as “t” in FIG. 2: a title of a chat screenshot. When the target picture is a private chat interface screenshot of an instant messaging application, “title” is a user name of a reciprocal account; when the target picture is a group chat interface screenshot of the instant messaging application, “title” is a group name of an instant messaging group.

“Avatar”, abbreviated as “a” in FIG. 2: an avatar of an account, including avatars of the other party and oneself, which is usually square, rounded square or round.

“Username”, abbreviated as “u” in FIG. 2: a nickname of an account, which usually appears during group chat.

“Content”, abbreviated as “c” in FIG. 2: chat content, it may be a word, a picture, an expression package, web page reference information, resource information, voice information, word reference information, etc. The “web page reference information” may be a jump link, that is, if the user clicks the jump link, a new page may be jumped; the “word reference information” may include word information for a speech of a certain account.

“Other”, abbreviated as “o” in FIG. 2: other content, including time information, message withdrawal information, group invitation information for a new account, prompt information for a certain account, modification of a group chat title, management information for an instant messaging group by an administrator, etc.

The OD module provided by the disclosure may be a multi-classification target detection model. For example, the OD module may be a You Only Look Once (YOLO), a Single Shot Multibox Detector (SSD), a RetinaNet and other models.

Compared with “title”, “username” and “avatar”, the OD module has a lower recall rate for “content” and “other”. In the “serial mode”, the error recognition of “content” and “other” by the OD module will affect the inference result of the OCR module, thus increasing the cumulative error of the overall scheme. Therefore, the disclosure also proposes a “parallel mode” to solve the problem under the “serial mode”.

In the “parallel mode”, the target picture may be sent to the OD module and the OCR module for inference at the same time, and a detection result of the OD module and a recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

In operation 103, a target region to be occluded may be determined (or identified) from the target picture based on results of the region type detection and the character recognition.

According to the embodiment of the disclosure, the target type detection technology (OD) may be used to perform the region type detection on the target picture may be performed by the target type detection technology (OD) to obtain a first type region and a second type region, and the character recognition on the target picture or the second type region may be performed by the optical character recognition technology (OCR), to obtain a character region. The first type region may be a region type to be occluded, and the second type region may be a region type not to be occluded. Moreover, the “first type region” may be the aforementioned “title”, “username” or “avatar”; the “second type region” may be the aforementioned “content” or “other”.

Next, entity recognition may be performed based on the character region to obtain an entity content region and a non-entity content region. Then, the first type region and entity content region may be determined as the target region to be occluded, that is, “title”, “username”, “avatar” and the entity content region may be determined as the target region to be occluded.

The disclosure may use a Natural Language Processing (NLP) module to perform the entity recognition. Here, the NLP module mainly performs a Named Entity Recognition (NER) task, extracts a relevant entity and determines (or identifies) whether it is privacy information.

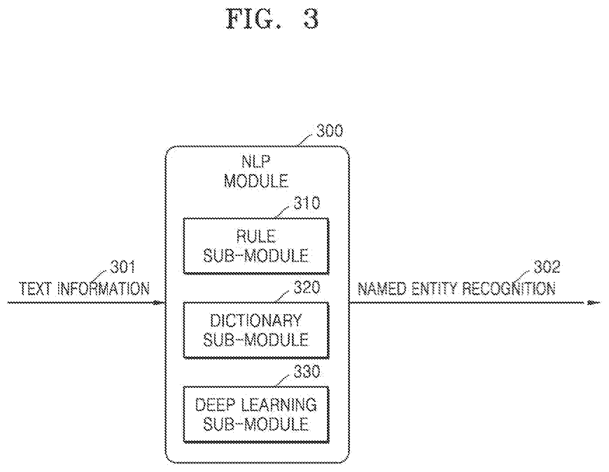

FIG. 3 is a schematic diagram showing an overall design of an NLP module 300 according to an embodiment of the disclosure. Referring to FIG. 3, the NLP module 300 may contain three sub-modules, namely a “rule sub-module 310”, a “dictionary sub-module 320” and a “deep learning sub-module 330”. After text information 301 is input into the NLP module 300, the NLP module 300 may perform the named entity recognition 302 with respect to the input text information 301.

The rule sub-module 310 may use a predefined rules to identify named entities. The predefined rules may include part-of-speech rules, word rules, and sentence rules. For example, the rule sub-module 310 may, by using the predefined rules, identify or recognize named entities such as names/aliases, addresses, social security numbers, phone numbers, bank account numbers, vehicle registration numbers, email address, messenger IDs (for example, QQ numbers), shipping numbers, flight numbers, etc. The dictionary sub-module 320 may identify or recognize named entities by using named entities that are registered in a dictionary. For example, the dictionary sub-module 320 may, by using a dictionary of named entities, identify or recognize named entities such as names/aliases, addresses, social security numbers, phone numbers, bank account numbers, vehicle registration numbers, email address, messenger IDs (for example, QQ numbers), shipping numbers, flight numbers, etc. The deep learning sub-module 330 may identify or recognize named entities by using artificial neural networks. For example, the deep learning sub-module 330 may, by using the artificial neural networks, identify or recognize named entities such as names/aliases, addresses, social security numbers, phone numbers, bank account numbers, vehicle registration numbers, email address, messenger IDs (for example, QQ numbers), shipping numbers, flight numbers, etc.

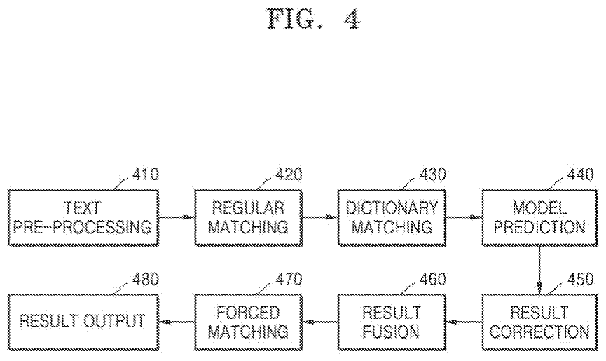

FIG. 4 is a schematic diagram showing a processing flow of the NLP module 300 according to an embodiment of the disclosure. Referring to FIG. 4, the process of named entity recognition through the NLP module 300 may be performed by the electronic device 1600 or a picture processing apparatus 1500 to be described later and may include 8 operations, including “text pre-processing 410”, “regular matching 420”, “dictionary matching 430”, “model prediction 440”, “result correction 450”, “result fusion 460”, “forced matching 470”, and “result output 480”, among which:

i. Text pre-processing 410: for text information obtained from the OCR module, some pre-processing work is needed, such as filtering some unnecessary characters and punctuation.

ii. Regular matching 420: the “rule sub-module 310” may use regular expression, string template, and other methods to get a NER result.

iii. Dictionary matching 430: the “Dictionary sub-module 320” may use an AC (Aho-Corasick) algorithm to load a custom dictionary into a dictionary tree, and then match the text to get a NER result.

iv. Model prediction 440: the “deep learning sub-module 330” mainly uses a deep learning model to extract a NER result from the text information 301, wherein the “deep learning model” may be, but not limited to, the following models:

A Bidirectional Long-Term Memory Conditional Random Field (BiLSTM-CRF) model; a Bidirectional Encoder Representations from Transformers (BERT) model; An Efficient Learning an Encoder that Classifies Token Replacements Accurately (ELECTRA) model and so on.

Because the screenshot privacy protection model pays more attention to information security, the “deep learning model 330” here may be designed as an On Device AI model. The On Device AI model is a model that may perform AI functions on the electronic device 1600 or the picture processing apparatus. It is recommended to use the BilSTM-CRF model with a relatively low complexity, less parameters and a faster running speed.

v. Result correction 450: the NER results extracted from different sub-modules, including the “rule sub-module 310”, the “dictionary sub-module 320” and the “deep learning sub-module 330” are filtered and adjusted.

vi. Result fusion 460: the NER results output by different sub-modules, including the “rule sub-module 310”, the “dictionary sub-module 320” and the “deep learning sub-module 330” are combined, and priorities of the NERs generated by different extraction methods are predefined. The higher the score is, the higher the priority is.

vii. Forced matching 470: a fusion result for different sub-module is forced to be corrected.

viii. Result output 480: a final NER result is output.

According to the embodiment of the disclosure, in a case that the above character region is a character region obtained by performing the character recognition on the second type region using the optical character recognition (OCR) technology, the entity recognition may be performed on the character region to obtain the entity content region and the non-entity content region. That is, in a case that the above character region is a character region obtained by performing the character recognition on the second type region such as “content” and “other” using the optical character recognition (OCR) technology, the entity recognition may be directly performed on the character region to obtain the entity content region and the non-entity content region.

As mentioned above, the first type region and the second type region obtained by the OD module for the region type detection of the target picture may be rectangular regions (the rectangular region 1, the rectangular region 2). When the optical character recognition (OCR) technology is used for the character recognition of the second type region, first of all, a picture corresponding to the second type region may be cut out. For example, referring to the figure (the target picture 2a) on the left in FIG. 2, a picture of a second type region containing word content of “Erwei patted Ning Mingyu” may be first cut out. For example, the OCR module may first cut out a rectangular region containing the word content of “Erwei patted Ning Mingyu” by using the OCR technology. Next, the OCR module may perform the character recognition on the cut picture of the second type region to obtain the word information contained in the picture of the second type region. For example, the OCR module may perform the character recognition on the rectangular region containing the word content of “Erwei patted Ning Mingyu”, and the word information of “Erwei patted Ning Mingyu” contained in the rectangular region is obtained.

According to the embodiment of the disclosure, in a case that the above character region is a character region obtained by performing the character recognition on the target picture using the optical character recognition (OCR) technology, the entity recognition may be performed based on the first type region, the second type region and the character region to obtain the entity content region and the non-entity content region. For example, in a case that the above character region is a character region obtained by performing the character recognition on the entire target picture itself using the optical character recognition (OCR) technology, the entity recognition may be performed based on the first type region such as “title”, “username”, “avatar”, the second type region such as “content”, “other”, and the character region obtained by character recognition on the entire target picture, to obtain the entity content region and the non-entity content region.

The character region obtained by performing the character recognition on the target picture by the OCR module may also be a rectangular region. Returning to the figure (or the target picture 2a) on the left in FIG. 2, the first type region obtained by performing the region type detection of the target picture by the OD module may contain a rectangular region 1, which contains a small icon “p” and two lines of words: “Group of captains of Haruka (2609)” and “2132 people line”; the character region obtained by performing the character recognition on the target picture by the OCR module may contain a rectangular region 2, which only contains two lines of words: “Group of captains of Haruka (2609)” and “2132people line” and does not contain the small icon “p”. It may be seen that the rectangular region 1 obtained by performing the region type detection of the target picture by the OD module coincides with the rectangular region 2 obtained by performing the character recognition on the target picture by the OCR module to a high degree, that is, an intersection region of the rectangular region 1 and the rectangular region 2 is relatively large.

According to the embodiment of the disclosure, a first intersection over Union (IoU) between the character region and the first type region and a second IoU between the character region and the second type region may be calculated. As mentioned earlier, the first type region and the second type region obtained by performing the region type detection of the target picture by the OD module may be rectangular regions, and the character region obtained by performing the character recognition on the target picture by the OCR module may also be a rectangular region. At this time, an IoU between each of multiple rectangular regions recognized by the OCR module and each of multiple rectangular regions detected by the OD module may be calculated.

Next, a first character region where the first IoU with the first type region is greater than or equal to a preset threshold in the character region may be determined. That is, the first character region that has a higher IoU with the first type regions “title”, “username” and “avatar” in the character region may be determined.

For example, referring to the figure (the target picture 2a) on the left of FIG. 2, as mentioned earlier, the rectangular region 1 obtained by performing the region type detection on the target picture by the OD module coincides with the rectangular region 2 obtained by performing the character recognition on the target picture by the OCR module to a high degree, that is, the intersection region of the rectangular region 1 and the rectangular region 2 is relatively large. At this time, the rectangular region 2 recognized by the OCR module may be determined as the first character region where the first IoU with the first type region “title” is greater than or equal to the preset threshold. For the first type regions “username” and “avatar”, the first character regions where the first IoUs with the first type regions “username” and “avatar” are greater than or equal to the preset threshold are found in all character regions obtained by performing the character recognition on the target picture, by using the above similar method.

Then, the entity recognition may be performed based on the second type region and a second character region in the character region other than the first character region to obtain the entity content region and the non-entity content region. That is, the entity recognition may be performed based on the second type region such as “content” and “other”, and the second character region in the character region other than the first character region that matches the first type region, to obtain the entity content region and the non-entity content region.

According to the embodiment of the disclosure, in a case that there is a second target type region in the second type region where the second IoU with the second character region is greater than or equal to the preset threshold, it indicates that the second target type region is a region correctly recognized by the OD module. At this time, the entity recognition may be performed based on the second target type region to obtain the entity content region and the non-entity content region.

If the IOU between the second type region and the second character region is less than the preset threshold, it indicates that the second character region belongs to a region missed to be recognized by the OD module. At this time, the entity recognition may be performed based on the second character region to obtain the entity content region and the non-entity content region.

In this way, in the “parallel mode”, the target picture may be sent to the OD module and the OCR module for inference at the same time, and the detection result of the OD module and the recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

According to the embodiment of the disclosure, the detection result of the OD module is only respective rectangular regions, that is, the OD module may only detect the type of each region in the target picture, and the OD module may not detect the substance in the rectangular region. Therefore, the optical character recognition (OCR) technology may be used for the character recognition on the second target type region to obtain the second target character region, that is, the optical character recognition (OCR) technology may be used for the character recognition on the second target type region to obtain multiple word information. Next, the entity recognition may be performed based on the second target character region, that is, the entity recognition may be performed based on the multiple word information obtained from the character recognition on the second target type region by using OCR, to obtain the entity content region and the non-entity content region.

According to the embodiment of the disclosure, the above character region may contain at least one word, each word may correspond to a line number, and entity words contained in the entity content region may have a same entity number.

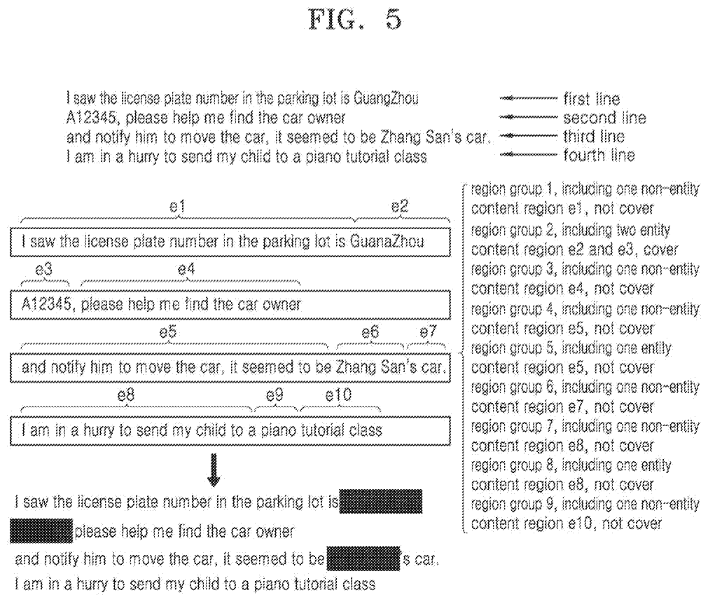

FIG. 5 is a schematic diagram of splitting, truncating and occluding a character region based on a line number corresponding to a word, an entity content region and a non-entity content region according to an embodiment of the disclosure. Referring to FIG. 5, word content contained in the character region is: “I saw the license plate number in the parking lot is GuanaZhou A12345, please help me find the car owner and notify him to move the car, it seemed to be Zhang San's car. I am in a hurry to send my child to a piano tutorial class”. It may be seen that the character region in FIG. 5 contains four lines of words. At this time, a line number corresponding to a first line of words may be 1, a line number corresponding to a second line of words may be 2, a line number corresponding to a third line of words may be 3, and a line number corresponding to a fourth line of words may be 4.

Further, the NLP module 300 may recognize a total of three pieces of entity content from the character region in FIG. 5, namely, “GuanaZhouA12345”; “Zhang San's”; “piano”, content in the character region in FIG. 5, except for the entity content recognized by the NLP module 300, is considered as the “non-entity content”. The entity numbers of “GuanaZhou”, “A”, “1”, “2”, “3”, “4” and “5” contained in the entity content of “GuanaZhouA12345” is the same, for example, the entity numbers may all be 11; the entity numbers of “Zhang” and “San” contained in the entity content of “Zhang San” is the same, for example, the entity numbers may be 12; the entity numbers of the entity content of “piano” may be, for example, 13.

First, the character region may be divided into multiple sub-regions based on the line number corresponding to each word, the entity content region and the non-entity content region. For example, referring to FIG. 5, in the first line of words, since “I saw the license plate number in the parking lot is” belongs to non-entity content, and “GuangZhou” belongs to entity content, the first line of words may be truncated into two sub-regions: e1 and e2; in the second line of words, since “A12345” belongs to the entity content, and “please help me find the car owner” belongs to the non-entity content, the second line of words may be truncated into two sub-regions: e3 and e4; in the third line of words, since “and notify him to move the car, it seemed to be” belongs to the non-entity content, “Zhang San” belongs to the entity content, and “'s car” belongs to the non-entity content, the third line of words may be truncated into three sub-regions: e5, e6 and e7; in the fourth line of words, since “I am in a hurry to send my child to” belongs to the non-entity content, “a piano” belongs to the entity content, and “tutorial class” belongs to the non-entity content, the fourth line of words may be truncated into three sub-regions: e8, e9, and e10.

Next, at least one sub-region including entity words with a same entity number in the plurality of sub-regions may be determined. For example, it may be determined that in the 10 sub-regions in FIG. 5, sub-regions including entity words with a same entity number 11 is e2 and e3; sub-regions including entity words with a same entity number 12 is e6; sub-regions including entity words with a same entity number 13 is e9.

Then, a type of entity content included in each of the at least one sub-region may be determined. For example, the entity content contained in the sub-regions e2 and e3 in FIG. 5 is “GuanaZhouA12345”, which belongs to a license plate number, thus, it may be confirmed that the type of the entity content contained in the sub-regions e2 and e3 conforms to the aforementioned preset privacy type; the type of the entity content contained in the sub-region e6 in FIG. 5 is “Zhang San”, which belongs to a name, thus, it may be confirmed that the type of entity content contained in the sub-region e6 conforms to the aforementioned preset privacy type; the entity content contained in the sub-region e9 in FIG. 5 is “a piano”, which belongs to a musical instrument, thus, it may be confirmed that the type of the entity content contained in the sub-region e9 does not conform to the aforementioned preset privacy type.

Next, a sub-region where type of entity content is a preset privacy type included in the at least one sub-region may be determined as the target region to be occluded. For example, the sub-regions e2, e3 and e6 whose types of entity content are the preset privacy type included in the at least one sub-region in FIG. 5 may be determined as the target region to be occluded.

In addition, it is also possible to determine all non-entity content regions, as well as entity content regions where types of contained entity content are not the preset privacy type, as regions that do not need to be occluded.

For example, referring to FIG. 5, at this time, the non-entity content region e1 forms a region group 1, and the region group 1 does not need to be occluded; the entity content regions e2 and e3 whose types of contained entity content are the preset privacy type form a region group 2, and the region group 2 needs to be occluded; the non-entity content region e4 forms a region group 3, and the region group 3 does not need to be occluded; the non-entity content region e5 forms a region group 4, and the region group 4 does not need to be occluded; the entity content region e6 whose type of contained entity content is the preset privacy type forms a region group 5, and the region group 5 needs to be occluded; the non-entity content region e7 forms a region group 6, and the region group 6 does not need to be occluded; the non-entity content region e8 forms a region group 7, and the region group 7 does not need to be occluded; the entity content region e9 whose type of contained entity content is not the preset privacy type forms a region group 8, and the region group 8 does not need to be occluded; the non-entity content region e10 forms a region group 9, and the region group 9 does not need to be occluded. In this way, the disclosure may also realize the recognition of the entity content in the newline words, and ensure that the cross-line privacy information may be accurately identified, and the accuracy of privacy information identification is high.

In operation 104, the target region may be occluded. For example, Gaussian fuzzy processing may be performed on the target region or the target region may be coded by a color block.

According to the embodiment of the disclosure, an effect picture of the target picture before and after the target region is occluded may also be displayed according to one of multiple preset display methods. Here, the multiple preset display methods may include an animation mode, a split screen mode and a touch mode.

The “animation mode” may refer to that in a way of animation, different transparency is used for the target region where the privacy information is located to achieve a gradual animation effect, which may not only display the original content of the target picture, but also display the effect after the target region of the target picture is occluded.

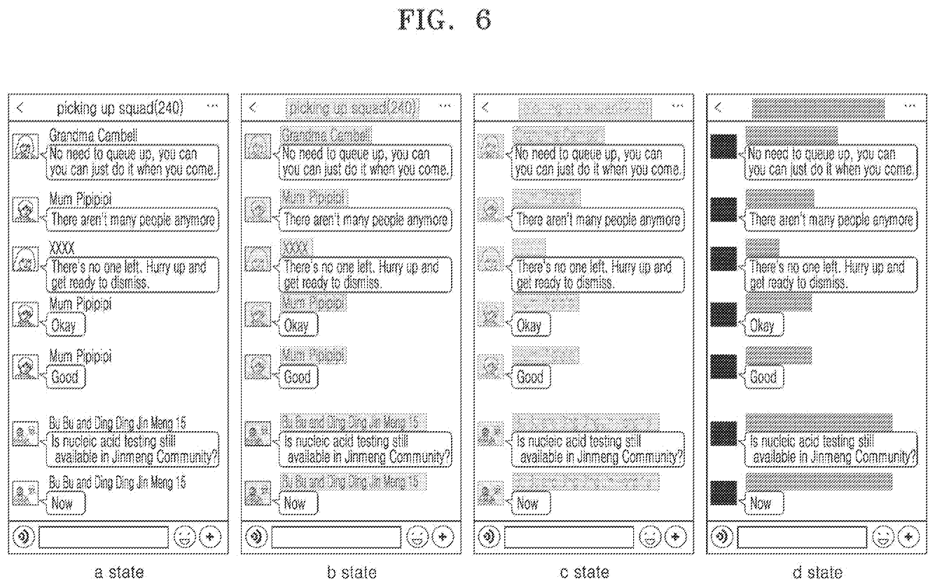

FIG. 6 is a schematic diagram showing an effect of displaying a target picture before and after a target region is occluded through an animation mode according to an embodiment of the disclosure.

Referring to FIG. 6, there are four display states from left to right. A target region where privacy information is located may gradually change from a full display state to an occluded state. Further, this animation effect may be designed to enter a next state every preset time interval. For example, it may be changed from a state->b state->c state->d state according to a preset duration of 0.5 second; then, d state->c state->b state->a state may be displayed in an order from right to left and based on the preset duration of 0.5 second, and the cycle is continued.

The “split screen mode” refers to that effect pictures of the target picture before and after the target region is occluded may be displayed in split screen, that is, the effect picture of the target picture before the target region is occluded may be displayed in one split screen page, and the effect picture of the target picture after the target region is occluded may be displayed in another split screen page. The “split screen mode” may include a left and right split screen mode and an up and down split screen mode.

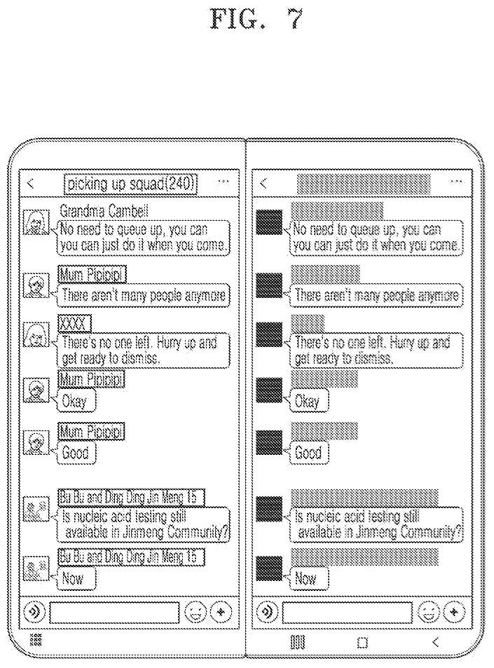

FIG. 7 is a schematic diagram showing an effect of displaying a target picture before and after a target region is occluded through a left and right split screen mode according to an embodiment of the disclosure.

Referring to FIG. 7, the left figure is an effect picture of highlighting the target region. For example, a border may be used to enclose the target region where the privacy information is located to remind the user of the region to be occluded; the right figure is an effect picture after occluding the target region where the privacy information is located.

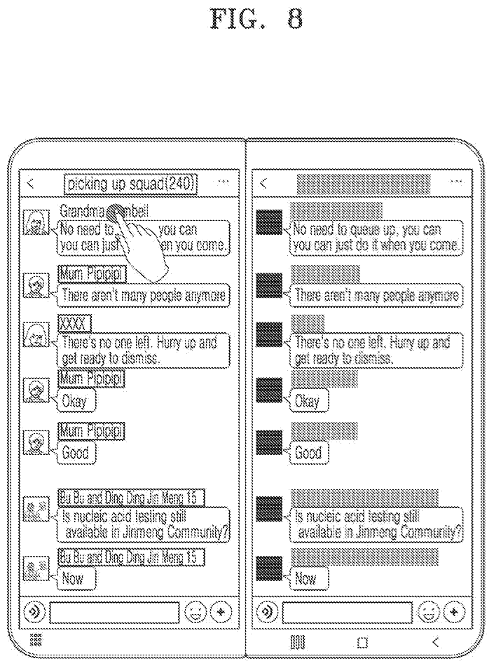

Further, a user's operation on a certain region within a split screen page will also affect the display effect of the corresponding region within the other split screen page. FIG. 8 is a schematic diagram showing a user's operation on a “username” region in a split screen page according to an embodiment of the disclosure. Referring to FIG. 8, the user clicks the “username” region of “Grandma Cambell” in the left split screen page. At this time, the border for highlighting this “username” region of “Grandma Cambell” in the left split screen page may be deleted, and the privacy coding effect of the “username” region of “Grandma Cambell” in the right split screen page will be deleted synchronously.

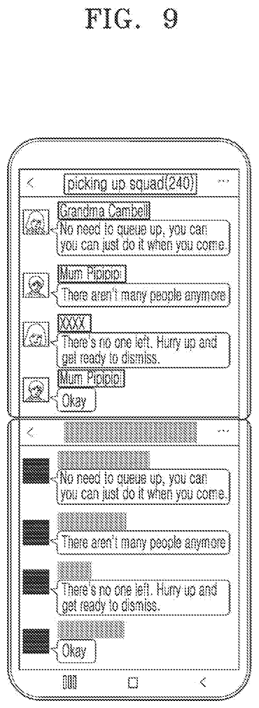

FIG. 9 is a schematic diagram showing an effect of displaying a target picture before and after a target region is occluded through an up and down split screen mode according to an embodiment of the disclosure.

Referring to FIG. 9, the above figure is an effect picture of highlighting the target region. For example, a border may be used to enclose the target region where the privacy information is located to remind the user of the region to be occluded; the below figure is an effect picture after occluding the target region where the privacy information is located.

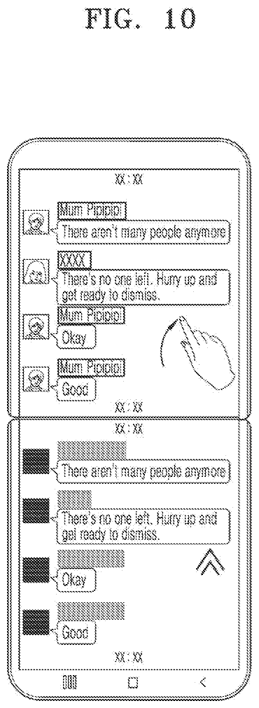

Similar to the left and right split screen mode, in the up and down split screen mode, the user's operation on a certain region within one split screen page in the up and down split screen will affect the display effect of the corresponding region in the other split screen page. For example, in the up and down split screen mode, if a user's sliding operation is performed in one split screen page of the up and down split screen to turn pages, the other split screen page will also turn pages synchronously based on the user's sliding operation. FIG. 10 is a schematic diagram showing a user's sliding operation in a split screen page according to an embodiment of the disclosure. Referring to FIG. 10, the user slides up in the above split page of the up and down split screen. At this time, the two split screens of the up and down split screen will turn pages synchronously in response to the sliding up operation.

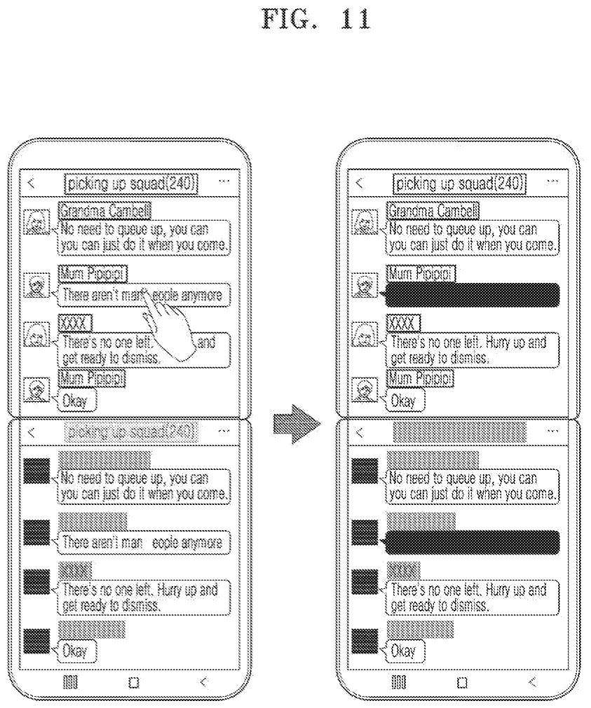

FIG. 11 is a schematic diagram showing a user's operation on a non-occluded region in a split screen page according to an embodiment of the disclosure. Referring to FIG. 11, the user clicks a “content” region of “There aren't many people anymore” in the above split screen page. At this time, the “content” region of “There aren't many people anymore” in the above split screen page may be covered, and the “content” region of “There aren't many people anymore” in the below split screen page will be occluded synchronously.

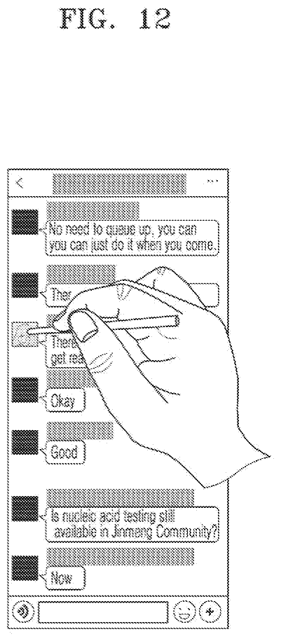

The “touch mode” mainly refers to a mode for a terminal (or an electronic device) with a stylus (S pen), a switch between occlusion and display may be realized by combining a hover function of S pen. FIG. 12 is a schematic diagram of hovering over an “avatar” region of a picture by a user using a stylus according to an embodiment of the disclosure. Referring to FIG. 12, if the user performs a hover operation over a third “avatar” region of the picture by using the stylus, the third “avatar” region may change from an original occluded state to a non-occluded state.

In the related technologies, some automatically occluded content is not what the user wants to occlude. The user needs to click multiple shielded regions to check and confirm what he/she wants to cover and what he/she doesn't want to cover, which is very inconvenient.

In the disclosure, it is possible to provide a contrast effect picture of the target picture before and after the target region is occluded, so that the user may clearly and quickly know what the occluded content is. It is not necessary for the user to click multiple occluded regions one by one to determine the region he/she really wants to cover, which may avoid complex operation steps and is efficient.

According to the embodiment of the disclosure, one preset display method that matches a type of the terminal (or the electronic device) may be selected from the plurality of preset display methods according to the type of the terminal (or the electronic device).

For example, if the terminal type (or the electronic device type) is a folding screen terminal (or a folding screen), that is, if the terminal (or the electronic device) contains at least two display screens, the split screen mode may be selected to display the effect pictures of the target picture before and after the target region is occluded; If the terminal type (or the electronic device type) is a single-screen terminal (or a single-screen), that is, if the terminal (or the electronic device) only contains one display screen, the animation mode may be selected to display the effect picture of the target picture before and after the target region is occluded, or in other ways.

In addition to selecting the display method according to the terminal type (or the electronic device type), the user may also manually select an appropriate display method from a variety of preset display methods according to his own needs. The disclosure is not limited to this.

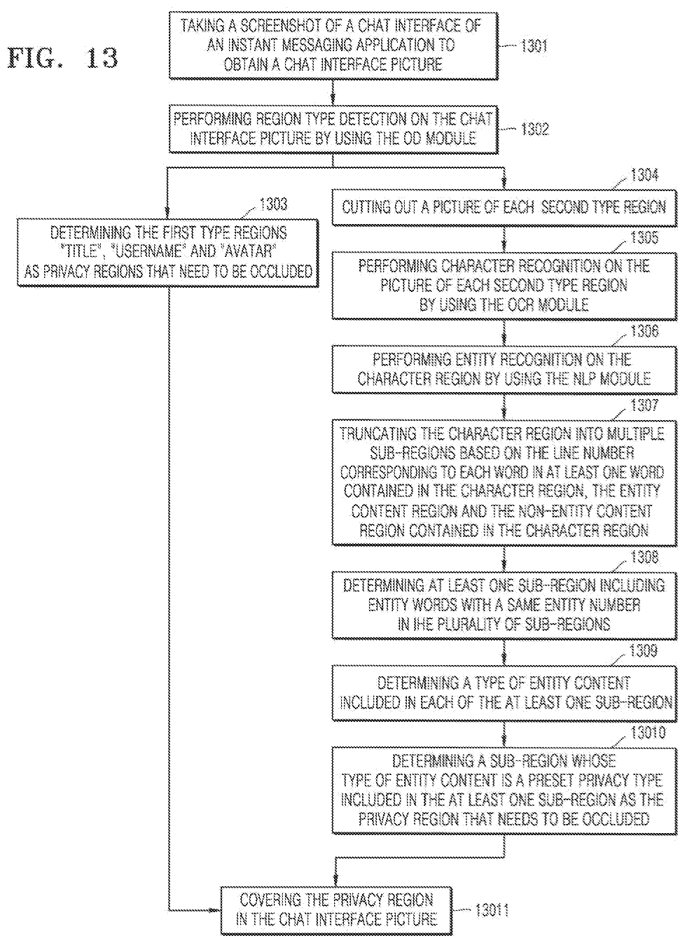

FIG. 13 is a flow chart showing privacy information identification and occlusion by using a serial mode for according to an embodiment of the disclosure. The privacy information identification and occlusion in FIG. 13 may be performed by the electronic device 1600 or the picture processing apparatus 1500.

Referring to FIG. 13, in operation 1301, a screenshot of a chat interface of an instant messaging application is taken to obtain a chat interface picture.

In operation 1302, the OD module is used to perform region type detection on the chat interface picture to obtain a result of the region type detection. The result of the region type detection may be divided into two types: first type regions “title”, “username” and “avatar”, and second type regions “content” and “other”.

In operation 1303, for the first type regions “title”, “username” and “avatar”, the first type regions “title”, “username” and “avatar” may be directly determined as privacy regions that need to be occluded.

In operation 1304, for the second type regions “content” and “other”, a picture of each second type region may be cut out (or captured).

In operation 1305, the OCR module is used to perform character recognition on the picture of each second type region to obtain a character region. Wherein, the character region may contain at least one word, and each word may have its own line number. The “line number” is used to indicate which line of the character region the corresponding word is located.

In operation 1306, the NLP module 300 is used to perform entity recognition on the character region to obtain an entity content region and a non-entity content region. Wherein, the entity words contained in each entity content region correspond to the same entity serial number.

In operation 1307, the character region is truncated into multiple sub-regions based on the line number corresponding to each word in at least one word contained in the character region, the entity content region and the non-entity content region contained in the character region. Wherein, as long as the entity types are different or the line numbers corresponding to the words are different in the character region, it may be truncated into a new sub-region.

In operation 1308, at least one sub-region including entity words with a same entity number in the plurality of sub-regions is determined.

In operation 1309, a type of entity content included in each of the at least one sub-region is determined.

In operation 13010, a sub-region where type of entity content is a preset privacy type included in the at least one sub-region is determined as the privacy region that needs to be occluded. Wherein, the “preset privacy type” mentioned in the disclosure may include, but not limited to, the following items: a name, an avatar, an ID card number, an instant messaging group title, a phone number, a bank card account number, a license plate number, an address, an email, an express number, a flight number.

In operation 13011, the privacy region in the chat interface picture is covered. For example, the “covered” method may be Gaussian fuzzy processing or coding by a color block.

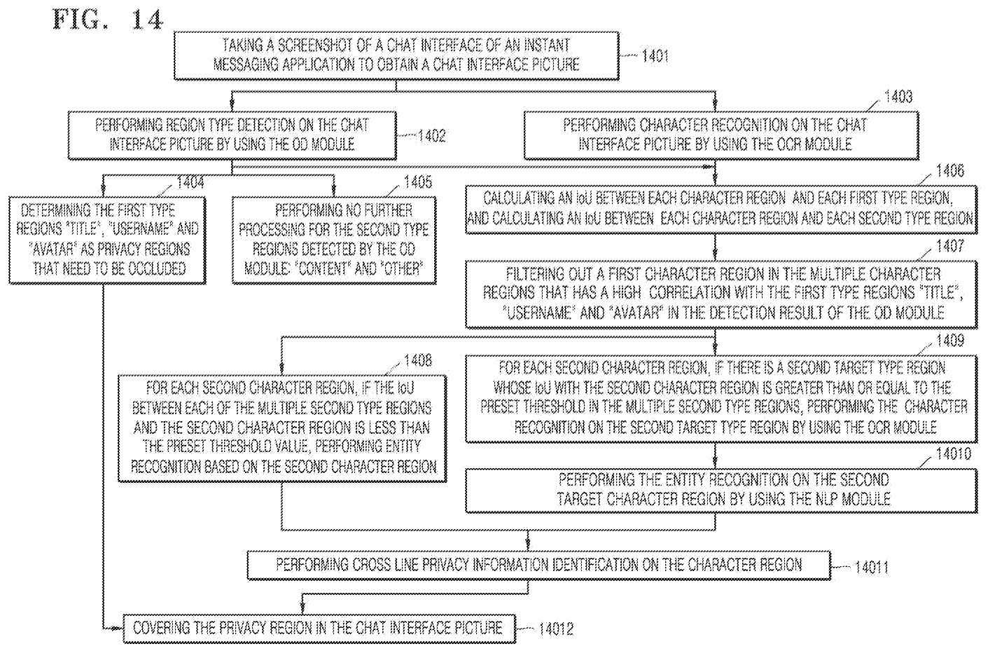

FIG. 14 is a flow chart showing privacy information identification and occlusion by using a parallel mode according to an embodiment of the disclosure. The information identification and occlusion in FIG. 14 may be performed by the electronic device 1600 or the picture processing apparatus 1500.

Referring to FIG. 14, in operation 1401, a screenshot of a chat interface of an instant messaging application is taken to obtain a chat interface picture.

In operation 1402, the OD module is used to perform region type detection on the chat interface picture to obtain multiple first type regions “title”, “username” and “avatar”, and multiple second type regions “content” and “other”. The first type of regions “title”, “username” and “avatar” have obvious features, and generally there will be no missing recognition.

In operation 1403, the OCR module is used to perform character recognition on the chat interface picture to obtain multiple character regions.

In operation 1404, for the first type regions detected by the OD module: “title”, “username” and “avatar”, the first type regions “title”, “username” and “avatar” are directly determined as the privacy regions that need to be occluded.

In operation 1405, for the second type regions detected by the OD module: “content” and “other”, no further processing will be performed.

In operation 1406, an IoU between each of the multiple character regions obtained by performing the character recognition on the entire chat interface picture by the OCR module and each of the multiple first type regions detected by the OD module is calculated, and an IoU between each of the multiple character regions and each of the multiple second type regions detected by the OD module is calculated.

As mentioned earlier, the first type regions and the second type regions obtained by performing region type detection on the chat interface picture by the OD module may be rectangular regions, and the character regions obtained by performing the character recognition on the chat interface picture by the OCR module may also be rectangular regions. Therefore, when calculating the IoU, it is actually calculating IoUs between the multiple rectangular character regions obtained by performing the character recognition on the entire chat interface picture by the OCR module and the multiple first type rectangular regions detected by the OD module, as well as IoUs between the multiple rectangular character regions obtained by performing the character recognition on the entire chat interface picture by the OCR module and the multiple second type rectangular regions detected by OD module.

In operation 1407, a first character region where IoU with the first type region is greater than or equal to a preset threshold in the multiple character regions is determined. Wherein, the greater the IoU is, the higher the correlation between the two regions is.

Since the first type regions “title”, “username” and “avatar” have been determined as the privacy regions to be occluded in operation 1404, the first character region in the multiple character regions that has a high correlation with the first type regions “title”, “username” and “avatar” in the detection result of the OD module may be filtered out, so as to avoid the repeated processing for the first character region that has a high correlation with the first type regions “title”, “username” and “avatar” in subsequent operations.

In operation 1408, for each second character region other than the first character region in the multiple character regions, if the IoU between each of the multiple second type regions and the second character region is less than the preset threshold value, it indicates that the second character region belongs to a region that is missed to be recognized by the OD module. At this time, entity recognition may be performed based on the second character region, to obtain the entity content region and the non-entity content region.

In operation 1409, for each second character region other than the first character region in the multiple character regions, if there is a second target type region where IoU with the second character region is greater than or equal to the preset threshold, it indicates that the second target type region is a region that is correctly recognized by the OD module. At this time, the character recognition on the second target type region may be performed by the OCR module, to obtain the second target character region.

In operation 14010, the entity recognition on the second target character region is performed by the NLP module 300 to obtain the entity content region and the non-entity content region.

In operation 14011, cross-line privacy information identification is performed on the character region. Wherein, the “cross-line privacy information identification” is a process of truncating the character region into multiple sub-regions based on the line number corresponding to each word in at least one word contained in the character region, the entity content region and the non-entity content region contained in the character region, and finding a privacy region in the truncated multiple sub-regions. The specific implementation process of the “cross-line privacy information identification” has been described in detail in the above embodiments, and will not be repeated here.

In operation 14012, the privacy region in the chat interface picture is covered. For example, the “covered” method may be Gaussian fuzzy processing or coding by a color block.

In this way, in the “parallel mode”, the chat interface picture may be sent to the OD module and OCR module for inference at the same time, and the detection result of the OD module and the recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

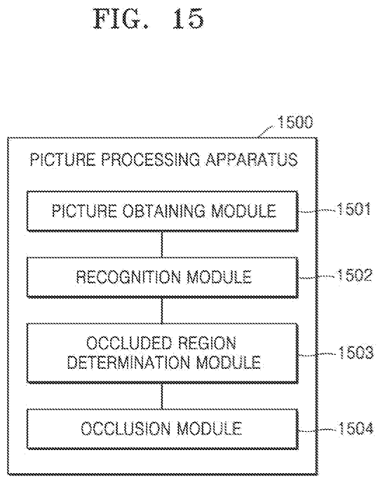

FIG. 15 is a block diagram showing a picture processing apparatus according to an embodiment of the disclosure.

Referring to FIG. 15, the picture processing apparatus 1500 may include a picture obtaining module (or a picture acquisition module) 1501, a recognition module 1502, an occluded region determination module (or an occluded region identification module) 1503 and an occlusion module 1504.

The picture obtaining module 1501 may obtain (or acquire) a target picture. For example, when a user performs a screenshot operation, the picture obtaining module 1501 may determine (or identify) whether a current display interface is an instant messaging group interface. For example, the picture obtaining module 1501 may determine whether the current display interface is a chat interface. If it is determined that the current display interface is the chat interface, the picture obtaining module 1501 may trigger a privacy information shield function for a chat interface screenshot obtained through the screenshot operation. For example, the picture obtaining module 1501 may perform privacy information identification and privacy information occlusion for the chat interface screenshot.

Or, when the user opens a picture in a gallery, the picture obtaining module 1501 may determine (or identify) whether the opened picture is a chat interface picture through a two-category artificial intelligence (AI) model. If it is determined that the picture currently opened by the user is the chat interface picture, the picture obtaining module 1501 may trigger the privacy information shield function for the chat interface picture.

The “privacy information”, i.e., “preset privacy type” referred to in the disclosure may include, but not limited to, the following items: a name, an avatar, an ID card number, an instant messaging group title, a phone number, a bank card account number, a license plate number, an address, an email, an express number, a flight number.

The recognition module 1502 may perform the region type detection and character recognition on the target picture by combining a target type detection technology and an optical character recognition technology.

The privacy identification of the target picture in the disclosure may be realized in two different ways, namely a “serial mode” and a “parallel mode”. The “serial mode” means that an OD module and an OCR module are serial, that is, the OCR module performs an operation such as screenshot by category in an output result of the OD module, and then performs character recognition on an intercepted region.

The “parallel mode” means that the OD module and the OCR module are parallel. The “serial mode” is relatively simple to implement, but it depends on the accuracy of the OD module, for example, an accuracy rate of the OD module, a recall rate of the OD module, a mAP of the OD module, and so on.

A total of five region types may be obtained by performing the region type detection on the target picture using the OD module, including “chat content (content)”, “other content (other)”, “a chat title (title)”, “a username of an account (username)”, and “an avatar of an account (avatar)”.

Compared with “title”, “username” and “avatar”, the OD module has a lower recall rate for “content” and “other”. In the “serial mode”, the error recognition of “content” and “other” by the OD module will affect the inference result of the OCR module, thus increasing the cumulative error of the overall scheme. Therefore, the disclosure also proposes a “parallel mode” to solve the problem under the “serial mode”.

In the “parallel mode”, the target picture may be sent to the OD module and the OCR module for inference at the same time, and a detection result of the OD module and a recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

The occluded region determination module 1503 may determine a target region to be occluded from the target picture based on the results of the region type detection and the character recognition.

According to the embodiment of the disclosure, the recognition module 1502 may perform the region type detection on the target picture by the target type detection technology (OD), to obtain a first type region and a second type region, and may perform the character recognition on the target picture or the second type region by the optical character recognition technology (OCR), to obtain a character region. The first type region may be a region type to be occluded, and the second type region may be a region type not to be occluded. Moreover, the “first type region” may be the aforementioned “title”, “username” or “avatar”; the “second type region” may be the aforementioned “content” or “other”.

Next, the occluded region determination module 1503 may perform entity recognition based on the character region to obtain an entity content region and a non-entity content region. Then, the occluded region determination module 1503 may determine the first type region and entity content region as the target region to be occluded, that is, may determine “title”, “username”, “avatar” and the entity content region as the target region to be occluded.

According to the embodiment of the disclosure, in a case that the above character region is a character region obtained by performing the character recognition on the second type region using the optical character recognition technology (OCR), the occluded region determination module 1503 may perform the entity recognition on the character region to obtain the entity content region and the non-entity content region. That is, in a case that the above character region is a character region obtained by performing the character recognition on the second type region such as “content” and “other” using the optical character recognition technology (OCR), the occluded region determination module 1503 may directly perform the entity recognition on the character region to obtain the entity content region and the non-entity content region.

According to the embodiment of the disclosure, in a case that the above character region is a character region obtained by performing the character recognition on the target picture using the optical character recognition technology (OCR), the occluded region determination module 1503 may perform the entity recognition based on the first type region, the second type region and the character region to obtain the entity content region and the non-entity content region. That is, in a case that the above character region is a character region obtained by performing the character recognition on the entire target picture itself using the optical character recognition technology (OCR), the occluded region determination module 1503 may perform the entity recognition based on the first type region such as “title”, “username”, “avatar”, the second type region such as “content”, “other”, and the character region obtained by character recognition on the entire target picture, to obtain the entity content region and the non-entity content region.

According to the embodiment of the disclosure, the occluded region determination module 1503 may calculate an intersection over Union (IoU) between the character region and the first type region and an IoU between the character region and the second type region. As mentioned earlier, the first type region and the second type region obtained by performing the region type detection of the target picture by the OD module may be rectangular regions, and the character region obtained by performing the character recognition on the target picture by the OCR module may also be a rectangular region. At this time, an IoU between each of multiple rectangular regions recognized by the OCR module and each of multiple rectangular regions detected by the OD module may be calculated.

Next, the occluded region determination module 1503 may determine a first character region where IoU with the first type region is greater than or equal to a preset threshold in the character region. That is, the first character region that has a higher IoU with the first type regions “title”, “username” and “avatar” in the character region may be determined.

Then, the occluded region determination module 1503 may perform the entity recognition based on the second type region and a second character region in the character region other than the first character region to obtain the entity content region and the non-entity content region. That is, the entity recognition may be performed based on the second type region such as “content”, “other”, and the second character region in the character region except the first character region that matches the first type region, to obtain the entity content region and the non-entity content region.

According to the embodiment of the disclosure, in a case that there is a second target type region in the second type region where IoU with the second character region is greater than or equal to the preset threshold, it indicates that the second target type region is a region correctly recognized by the OD module. At this time, the occluded region determination module 1503 may perform the entity recognition based on the second target type region to obtain the entity content region and the non-entity content region.

If the IOU between the second type region and the second character region is less than the preset threshold, it indicates that the second character region belongs to a region missed to be recognized by the OD module. At this time, the occluded region determination module 1503 may perform the entity recognition based on the second character region to obtain the entity content region and the non-entity content region.

In this way, in the “parallel mode”, the target picture may be sent to the OD module and the OCR module for inference at the same time, and the detection result of the OD module and the recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

According to the embodiment of the disclosure, the detection result of the OD module is only respective rectangular regions, that is, the OD module may only detect the type of each region in the target picture, and the OD module may not detect the substance in the rectangular region. Therefore, the occluded region determination module 1503 may perform the character recognition on the second target type region by the optical character recognition technology (OCR) to obtain the second target character region, that is, may perform the character recognition on the second target type region by the optical character recognition technology (OCR) to obtain multiple word information. Next, the occluded region determination module 1503 may perform the entity recognition based on the second target character region, that is, may perform the entity recognition based on the multiple word information obtained from the character recognition on the second target type region by using OCR, to obtain the entity content region and the non-entity content region.

According to the embodiment of the disclosure, the above character region may contain at least one word, each word may correspond to a line number, and entity words contained in the entity content region may have a same entity number. The occluded region determination module 1503 may be configured to divide the character region into a plurality of sub-regions based on the line number corresponding to each word, the entity content region and the non-entity content region; determine at least one sub-region including entity words with a same entity number in the plurality of sub-regions; determine a type of entity content included in each of the at least one sub-region; determine a sub-region where type of entity content is a preset privacy type included in the at least one sub-region, as the target region to be occluded.

The occlusion module 1504 may occlude the target region. For example, Gaussian fuzzy processing may be performed on the target region or the target region may be coded by a color block.

According to the embodiment of the disclosure, the picture processing apparatus 1500 may also include an effect picture display module configured to display an effect picture of the target picture before and after the target region is occluded according to one of a plurality of preset display methods, wherein the plurality of preset display methods include an animation mode, a split screen mode and a touch mode.

The “animation mode” may refer to that in a way of animation, different transparency is used for the target region where the privacy information is located to achieve a gradual animation effect, which may not only display the original content of the target picture, but also display the effect after the target region of the target picture is occluded.

The “split screen mode” refers to that effect pictures of the target picture before and after the target region is occluded may be displayed in split screen, that is, the effect picture of the target picture before the target region is occluded may be displayed in one split screen page, and the effect picture of the target picture after the target region is occluded may be displayed in another split screen page. The “split screen mode” may include a left and right split screen mode and an up and down split screen mode.

The “touch mode” mainly refers to that for a terminal (or the picture processing apparatus 1500) with a stylus (S pen), a switch between occlusion and display may be realized by combining a hover function of S pen.

In the related technologies, some automatically occluded content is not what the user wants to occlude. The user needs to click multiple shielded regions to check and confirm what he/she wants to cover and what he/she doesn't want to cover, which is very inconvenient.

While in the disclosure, it is possible to provide a contrast effect picture of the target picture before and after the target region is occluded, so that the user may clearly and quickly know what the occluded content is. It is not necessary for the user to click multiple occluded regions one by one to determine the region he/she really wants to cover, which may avoid complex operation steps and is efficient.

According to the embodiment of the disclosure, the effect picture display module may further select one preset display method that matches a type of the picture processing apparatus 1500 from the plurality of preset display methods according to the type of the picture processing apparatus 1500 to display the effect picture.

For example, if the picture processing apparatus type is a folding screen, that is, if the picture processing apparatus 1500 contains at least two display screens, the split screen mode may be selected to display the effect pictures of the target picture before and after the target region is occluded; If the picture processing apparatus type is a single-screen, that is, if the picture processing apparatus 1500 only contains one display screen, the animation mode may be selected to display the effect picture of the target picture before and after the target region is occluded, or in other ways.

In addition to selecting the display method according to the picture processing apparatus type, the user may also manually select an appropriate display method from a variety of preset display methods according to his own needs. The disclosure is not limited to this.

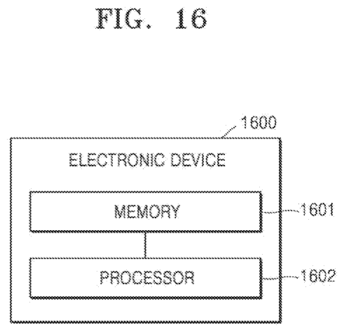

FIG. 16 is a block diagram showing an electronic device 1600 according to an embodiment of the disclosure.

Referring to FIG. 16, the electronic device 1600 includes at least one memory 1601 and at least one processor 1602. The at least one memory 1601 stores instructions that, when executed by the at least one processor 1602, causes the at least one processor 1602 to perform the picture processing method according to the embodiments of the disclosure.

As an example, the electronic device 1600 may be a PC computer, a tablet device, a personal digital assistant, a smartphone, or any other device capable of executing the above instruction set. Here, the electronic device 1600 does not have to be a single electronic device, but may also be any set of devices or circuits capable of executing the above instructions (or instruction set) individually or jointly. The electronic device 1600 may also be a part of an integrated control system or system manager, or may be configured as a portable electronic device that interfaces locally or remotely (e.g., via wireless transmission).

In the electronic device 1600, the processor 1602 may include a circuitry, such as a central processing unit (CPU), graphics processing unit (GPU), programmable logic device, special purpose processor system, microcontroller or microprocessor. By way of example and not limitation, the processor 1602 may also include analog processors, digital processors, microprocessors, multi-core processors, processor arrays, network processors, and the like.

The processor 1602 may execute instructions or code stored in the memory 1601, which may also store data. Instructions and data may also be sent and received over a network via a network interface apparatus, which may employ any known transport protocol.

The memory 1601 may be integrated with the processor 1602, e.g., a RAM or flash memory is arranged within an integrated circuit microprocessor or the like. Additionally, the memory 1601 may include a separate device such as an external disk drive, storage array, or any other storage device that may be used by a database system. The memory 1601 and the processor 1602 may be operatively coupled, or may communicate with each other, e.g., through I/O ports, network connections, etc., to enable the processor 1602 to read files stored in the memory.

In addition, the electronic device 1600 may also include video displays (e.g. liquid crystal display) and user interaction interfaces (e.g. keyboard, mouse, touch input device, etc.). All components of the electronic device 1600 may be connected to each other via a bus and/or a network.

According to an embodiment of the disclosure, a computer readable storage medium storing a computer program is also provided. The computer program, when executed by at least one processor, causes the at least one processor to perform the picture processing method according to the embodiments of the disclosure. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device such as client, host, proxy device, server and the like. In addition, in one example, the computer programs and any associated data, data files, and data structures are distributed on a networked computer system, so that the computer programs and any associated data, data files, and data structures are stored, accessed and executed through one or more processors or computers in a distributed manner.

According to an embodiment of the disclosure, a computer program product may also be provided in which the computer programs are included, and the computer programs may achieve, when executed by a processor, the picture processing method according to the disclosure.

The picture processing method, the apparatus (or the picture processing apparatus 1500), the electronic device 1600 and the storage medium according to the disclosure may be reduce the phenomenon that privacy information is incorrectly identified or missed to be identified, by performing the region type detection and the character recognition on the target picture through combining the target type detection technology and the optical character recognition technology; in addition, it may also realize the recognition of entity content in newline words, ensure that cross-line privacy information may be accurately identified, and the accuracy of privacy information identification is high.

Furthermore, in the “parallel mode”, the target picture may be sent to the OD module and the OCR module for inference at the same time, and the detection result of the OD module and the recognition result of the OCR module may be used to complement each other, so as to solve the problem that the OD module misses to recognize some “content” and “other” in the “serial mode”, which leads to no subsequent OCR inference, and may avoid the phenomenon of missing to recognize some “content” and “other”, ensure the accuracy and reliability of privacy information identification.

Furthermore, the present application may provide a contrast effect picture of the target picture before and after the target region is occluded, so that the user may clearly and quickly know what the occluded content is. It is not necessary for the user to click multiple occluded regions one by one to determine the region he/she really wants to cover, which may avoid complex operation steps and is efficient.

In an embodiment, the performing the region type detection and the character recognition on the target picture by combining the target type detection technology with the optical character recognition technology may include obtaining a first type region and a second type region by performing region type detection on the target picture using the target type detection technology, and obtaining a character region by performing character recognition on the target picture or the second type region using the optical character recognition technology, wherein the first type region is a region type to be occluded and the second type region is a region type not to be occluded.

In an embodiment, the determining the target region to be occluded from the target picture based on the result of the region type detection and the result of the character recognition may include obtaining an entity content region and a non-entity content region by performing entity recognition based on the character region, and determining the first type region and the entity content region as the target region to be occluded.

In an embodiment, the obtaining the entity content region and the non-entity content region by performing the entity recognition based on the character region may include, based on the character region obtained by performing the character recognition on the second type region using the optical character recognition technology, obtaining the entity content region and the non-entity content region by performing the entity recognition on the character region.

In an embodiment, the obtaining the entity content region and the non-entity content region by performing the entity recognition based on the character region may include, based on the character region obtained by performing the character recognition on the target picture using the optical character recognition technology, obtaining the entity content region and the non-entity content region by performing the entity recognition based on the first type region, the second type region, and the character region.

In an embodiment, the obtaining the entity content region and the non-entity content region by performing the entity recognition based on the first type region, the second type region, and the character region may include determining an intersection over union between the character region and the first type region, determining an intersection over union between the character region and the second type region, determining a first character region having an intersection over union with the first type region that is greater than or equal to a preset threshold in the character region, and obtaining the entity content region and the non-entity content region by performing the entity recognition based on the second type region and a second character region in the character region other than the first character region.

In an embodiment, the obtaining the entity content region and the non-entity content region by performing the entity recognition based on the second type region and the second character region in the character region other than the first character region may include, based on there being a second target type region in which an intersection over union with the second character region is greater than or equal to the preset threshold in the second type region, obtaining the entity content region and the non-entity content region by performing entity recognition based on the second target type region, and based on an intersection over union between the second type region and the second character region being less than the preset threshold, obtaining the entity content region and the non-entity content region by performing entity recognition based on the second character region.

In an embodiment, the obtaining the entity content region and the non-entity content region by performing the entity recognition based on the second target type region may include obtaining a second target character region by performing character recognition on the second target type region using the optical character recognition technology, and obtaining the entity content region and the non-entity content region by performing the entity recognition based on the second target character region.

In an embodiment, the character region may include at least one word, each word of the at least one word of the character region corresponds to a line number, entity words included in the entity content region have a same entity number, and the determining the entity content region as the target region to be occluded may include dividing the character region into a plurality of sub-regions based on the line number corresponding to each word of the character region, the entity content region and the non-entity content region, determining at least one sub-region including the entity words with a same entity number in the plurality of sub-regions, determining a type of entity content included in each of the at least one sub-region, and determining a sub-region having a type of entity content that is a preset privacy type of the at least one sub-region, as the target region to be occluded.

In an embodiment, the picture processing method may further include displaying an effect picture of the target picture before and after the target region is occluded based on one of a plurality of preset display methods, and the plurality of preset display methods include an animation mode, a split screen mode, and a touch mode.

In an embodiment, the displaying the effect picture of the target picture before and after the target region is occluded according to one of the plurality of preset display methods may include displaying the effect picture by selecting one preset display method that matches a type of the electronic device from the plurality of preset display methods based on the type of the electronic device.

In an embodiment, the at least one processor 1602 is further configured to obtain a first type region and a second type region by performing region type detection on the target picture using the target type detection technology, and obtain a character region by performing character recognition on the target picture or the second type region using the optical character recognition technology, wherein the first type region is a region type to be occluded and the second type region is a region type not to be occluded.

In an embodiment, the at least one processor 1602 is further configured to obtain an entity content region and a non-entity content region by performing entity recognition based on the character region and determine the first type region and the entity content region as the target region to be occluded.

In an embodiment, the at least one processor 1602 is further configured to, based on the character region being obtained by performing the character recognition on the second type region using the optical character recognition technology, obtain the entity content region and the non-entity content region by performing the entity recognition on the character region.

In an embodiment, the at least one processor 1602 is further configured to, based on the character region being obtained by performing the character recognition on the target picture using the optical character recognition technology, obtain the entity content region and the non-entity content region by performing the entity recognition on the first type region, the second type region, and the character region.

In an embodiment, the at least one processor 1602 is further configured to determine an intersection over union between the character region and the first type region, determine an intersection over union between the character region and the second type region, determine a first character region having an intersection over union with the first type region that is greater than or equal to a preset threshold in the character region, and obtain the entity content region and the non-entity content region by performing the entity recognition based on the second type region and a second character region in the character region other than the first character region.

In an embodiment, the at least one processor 1602 is further configured to, based on there being a second target type region in which an intersection over union with the second character region that is greater than or equal to the preset threshold in the second type region, obtain the entity content region and the non-entity content region by performing entity recognition based on the second target type region, and based on an intersection over union between the second type region and the second character region being less than the preset threshold, obtain the entity content region and the non-entity content region by performing entity recognition based on the second character region.

In an embodiment, the at least one processor 1602 is further configured to display an effect picture of the target picture before and after the target region is occluded based on one of a plurality of preset display methods, wherein the plurality of preset display methods comprise an animation mode, a split screen mode, and a touch mode.

After considering the specification and the practice of the invention disclosed herein, those skilled in the art will readily conceive of other implementations of the disclosure. This application is intended to cover any variation, use or adaptation of the disclosure that follows the general principles of the disclosure and includes the common knowledge or customary technical means in the field of technology not disclosed by the disclosure. The embodiments described and shown herein are only examples, and the true scope and spirit of the disclosure are indicated by the claims below.

It should be understood that embodiments of the disclosure are not limited to the precise structure already described above and shown in the attached drawings and are subject to various modifications and changes within the scope of the disclosure. The scope of the disclosure is limited only by the attached claims.

What is claimed is:

1. A picture processing method performed by an electronic device, the picture processing method comprising:
obtaining a target picture;
performing region type detection and character recognition on the target picture by combining a target type detection technology with an optical character recognition technology;
determining a target region to be occluded from the target picture based on a result of the region type detection and a result of the character recognition; and
occluding the target region in the target picture.

2. The picture processing method of claim 1, wherein the performing the region type detection and the character recognition on the target picture by combining the target type detection technology with the optical character recognition technology comprises:
obtaining a first type region and a second type region by performing region type detection on the target picture using the target type detection technology; and
obtaining a character region by performing character recognition on the target picture or the second type region using the optical character recognition technology, and
wherein the first type region is a region type to be occluded, and the second type region is a region type not to be occluded.

3. The picture processing method of claim 2, wherein the determining the target region to be occluded from the target picture based on the result of the region type detection and the result of the character recognition comprises:
obtaining an entity content region and a non-entity content region by performing entity recognition based on the character region; and
determining the first type region and the entity content region as the target region to be occluded.

4. The picture processing method of claim 3, wherein the obtaining the entity content region and the non-entity content region by performing the entity recognition based on the character region comprises:
based on the character region being obtained by performing the character recognition on the second type region using the optical character recognition technology, obtaining the entity content region and the non-entity content region by performing the entity recognition on the character region.

5. The picture processing method of claim 3, wherein the obtaining the entity content region and the non-entity content region by performing the entity recognition based on the character region comprises:
based on the character region being obtained by performing the character recognition on the target picture using the optical character recognition technology, obtaining the entity content region and the non-entity content region by performing the entity recognition on the first type region, the second type region, and the character region.

6. The picture processing method of claim 5, wherein the obtaining the entity content region and the non-entity content region by performing the entity recognition based on the first type region, the second type region, and the character region comprises:
determining an intersection over union between the character region and the first type region;
determining an intersection over union between the character region and the second type region;
determining a first character region having an intersection over union with the first type region that is greater than or equal to a preset threshold in the character region; and
obtaining the entity content region and the non-entity content region by performing the entity recognition based on the second type region and a second character region in the character region other than the first character region.

7. The picture processing method of claim 6, wherein the obtaining the entity content region and the non-entity content region by performing the entity recognition based on the second type region and the second character region in the character region other than the first character region comprises:
based on there being a second target type region in which an intersection over union with the second character region that is greater than or equal to the preset threshold in the second type region, obtaining the entity content region and the non-entity content region by performing entity recognition based on the second target type region; and
based on an intersection over union between the second type region and the second character region being less than the preset threshold, obtaining the entity content region and the non-entity content region by performing entity recognition based on the second character region.

8. The picture processing method of claim 7, wherein the obtaining the entity content region and the non-entity content region by performing the entity recognition based on the second target type region comprises:
obtaining a second target character region by performing character recognition on the second target type region using the optical character recognition technology; and
obtaining the entity content region and the non-entity content region by performing the entity recognition based on the second target character region.

9. The picture processing method of claim 3, wherein the character region comprises at least one word,
wherein each word of the at least one word of the character region corresponds to a line number,
wherein entity words comprised in the entity content region have a same entity number, and
wherein the determining the entity content region as the target region to be occluded comprises:
dividing the character region into a plurality of sub-regions based on the line number corresponding to each word of the character region, the entity content region and the non-entity content region;
determining at least one sub-region comprising the entity words with a same entity number in the plurality of sub-regions;
determining a type of entity content comprised in each of the at least one sub-region; and
determining a sub-region having a type of entity content that is a preset privacy type of the at least one sub-region, as the target region to be occluded.

10. The picture processing method of claim 1, further comprising displaying an effect picture of the target picture before and after the target region is occluded based on one of a plurality of preset display methods,
wherein the plurality of preset display methods comprise an animation mode, a split screen mode, and a touch mode.

11. The picture processing method of claim 10, wherein the displaying the effect picture of the target picture before and after the target region is occluded according to one of the plurality of preset display methods comprises displaying the effect picture by selecting one preset display method that matches a type of the electronic device from the plurality of preset display methods based on the type of the electronic device.

12. An electronic device comprising:
at least one processor; and
a memory storing instructions,
wherein the at least one processor is configured to execute the instructions to:
obtain a target picture;
perform region type detection and character recognition on the target picture by combining a target type detection technology with an optical character recognition technology;
determine a target region to be occluded from the target picture based on a result of the region type detection and a result of the character recognition; and
occlude the target region in the target picture.

13. The electronic device of claim 12, wherein the at least one processor is further configured to:
obtain a first type region and a second type region by performing region type detection on the target picture using the target type detection technology; and
obtain a character region by performing character recognition on the target picture or the second type region using the optical character recognition technology, and
wherein the first type region is a region type to be occluded and the second type region is a region type not to be occluded.

14. The electronic device of claim 13, wherein the at least one processor is further configured to:
obtain an entity content region and a non-entity content region by performing entity recognition based on the character region; and
determine the first type region and the entity content region as the target region to be occluded.

15. The electronic device of claim 14, wherein the at least one processor is further configured to:
based on the character region being obtained by performing the character recognition on the second type region using the optical character recognition technology, obtain the entity content region and the non-entity content region by performing the entity recognition on the character region.

16. The electronic device of claim 14, wherein the at least one processor is further configured to:
based on the character region being obtained by performing the character recognition on the target picture using the optical character recognition technology, obtain the entity content region and the non-entity content region by performing the entity recognition on the first type region, the second type region, and the character region.

17. The electronic device of claim 16, wherein the at least one processor is further configured to:
determine an intersection over union between the character region and the first type region;
determine an intersection over union between the character region and the second type region;
determine a first character region having an intersection over union with the first type region that is greater than or equal to a preset threshold in the character region; and
obtain the entity content region and the non-entity content region by performing the entity recognition based on the second type region and a second character region in the character region other than the first character region.

18. The electronic device of claim 17, wherein the at least one processor is further configured to:
based on there being a second target type region in which an intersection over union with the second character region that is greater than or equal to the preset threshold in the second type region, obtain the entity content region and the non-entity content region by performing entity recognition based on the second target type region; and
based on an intersection over union between the second type region and the second character region being less than the preset threshold, obtain the entity content region and the non-entity content region by performing entity recognition based on the second character region.

19. The electronic device of claim 12, the at least one processor is further configured to display an effect picture of the target picture before and after the target region is occluded based on one of a plurality of preset display methods,
wherein the plurality of preset display methods comprise an animation mode, a split screen mode, and a touch mode.

20. A computer readable storage medium storing instructions which are executed by a processor of an electronic device to perform a picture processing method comprising:
obtaining a target picture;
performing region type detection and character recognition on the target picture by combining a target type detection technology and an optical character recognition technology;
determining a target region to be occluded from the target picture based on a result of the region type detection and a result of the character recognition; and
occluding the target region in the target picture.
